(19) United States
(12) Patent Application Publication
(10) Pub. No.: US 2026/0109386 A1
(43) Pub. Date: Apr. 23, 2026

(54) MOVING CARRIER AND SEAT FOLDING METHOD THEREOF

(71) Applicant: UNIQUE PRODUCT & DESIGN CO., LTD., Tainan City (TW)

(72) Inventor: Chih-Ching CHENG, Tainan City (TW)

(21) Appl. No.: 19/364,060

(22) Filed: Oct. 21, 2025

Related U.S. Application Data
(60) Provisional application No. 63/709,632, filed on Oct. 21, 2024.

(51) Int. Cl. B62B 7/12; B62B 7/00; B62B 9/20

(52) U.S. Cl. CPC B62B 7/12; B62B 7/008; B62B 9/20

(57) ABSTRACT

A moving carrier and a seat folding method thereof. The moving carrier includes a body frame assembly, a seatback frame, a seat stand frame, a seat frame and a first unlocking mechanism. The body frame assembly includes a body stand frame and a bottom frame. The seatback frame is pivotally connected to the body stand frame. The seat stand frame is pivotally connected to the body frame assembly. The seat frame has a first end pivotally connected to the seatback frame and a second end pivotally connected to the seat stand frame. When the first unlocking mechanism unlocks a lock state between the seatback frame and the body frame assembly, the seatback frame moves from an unfolded position to a folded position, and while the seatback frame is moving from the unfolded position to the folded position, the seat stand frame is moving toward the bottom frame.

### CROSS REFERENCE TO RELATED APPLICATIONS

This Non-provisional application claims priority under 35 U.S.C. §119(a) on Patent Application No(s). 63/709,632 filed in United States of America on October 21, 2024, the entire contents of which are hereby incorporated by reference.

### BACKGROUND

### Technology Field

The present disclosure relates to a moving carrier and, in particular, to a moving carrier having a seat foldable design.

### Description of the Related Art

Small moving carriers with wheels, such as infant strollers, baby carriages, shopping carts or other types of moving carriers, can provide considerable convenience for people when traveling, daily leisure, shopping or entertainment.

A conventional moving carrier is provided with a seat, which can be used as a stroller for infants or children when going out. When the infants or children are not on board, if the seat can be folded, the moving carrier can be used as a storage trolley or cart.

### SUMMARY

An objective of this disclosure is to provide a moving carrier and a seat folding method thereof, so that the moving carrier with the unfolded seat can be used as an infant stroller or a baby carriage, and the moving carrier with the folded seat can be used as a storage trolley or cart.

To achieve the above, a moving carrier of this disclosure includes a body frame assembly, a seatback frame, a seat stand frame, a seat frame and a first unlocking mechanism. The body frame assembly includes a body stand frame and a bottom frame connected to the body stand frame. The seatback frame is disposed on the body frame assembly and pivotally connected to the body stand frame. The seat stand frame is pivotally connected to the body frame assembly. The seat frame has a first end and a second end opposite each other. The first end is pivotally connected to the seatback frame and adjacent to a pivotal connection of the seatback frame and the body stand frame, and the second end is pivotally connected to the seat stand frame. The first unlocking mechanism is disposed on the seatback frame and configured to unlock a lock state between the seatback frame and the body frame assembly. When the first unlocking mechanism unlocks the lock state between the seatback frame and the body frame assembly, the seatback frame moves from an unfolded position to a folded position, and while the seatback frame is moving from the unfolded position to the folded position, the seat stand frame is moving toward the bottom frame.

In one embodiment, in a top view of the moving carrier, a projection of the body frame assembly is substantially a quadrilateral.

In one embodiment, the body frame assembly further includes a top frame, and the top frame is connected to the bottom frame through the body stand frame.

In one embodiment, the body frame assembly includes a plurality of body stand frames, and each of the body stand frames connects to one of multiple corners of the bottom frame.

In one embodiment, the moving carrier includes a plurality of seatback frames, and the seatback frames are disposed opposite to each other.

In one embodiment, in the folded position, the seatback frames substantially form one plane.

In one embodiment, while the seatback frame is moving from the unfolded position to the folded position, the seatback frame and the seat frame are both moving toward the bottom frame.

In one embodiment, the seatback frame includes a seatback stand frame, the seatback stand frame is pivotally connected to the body stand frame through a first connection structure, and an extension direction of the seatback stand frame does not pass through a pivotal connection of the first connection structure and the body stand frame.

In one embodiment, the seatback frame includes a seatback stand frame, the first end of the seat frame is pivotally connected to the seatback stand frame through a second connection structure, the seat frame includes a supporting portion arranged at the first end, and when the seatback is in the folded position, the seatback stand frame is disposed on the supporting portion.

In one embodiment, the first unlocking mechanism includes a first hook structure, the body frame assembly further includes a second hook structure arranged corresponding to the first hook structure, and when the seatback frame is locked to the body frame assembly, the first hook structure is engaged with the second hook structure.

In one embodiment, the first unlocking mechanism further includes a first unlock member and a first connection member, the first unlock member is connected to the first hook structure through the first connection member, and when the first unlock member is pressed, the first unlock member carries, through the first connection member, the first hook structure to depart from the second hook structure, so as to unlock the lock state between the seatback frame and the body frame assembly.

In one embodiment, the first unlocking mechanism further includes a first stop member and a first elastic member, the first connection member passes through the first elastic member and connects the first hook structure, the first stop member is disposed on the seatback stand frame for fixing one end of the first elastic member, and another end of the first elastic member is connected to the first hook structure.

In one embodiment, the moving carrier further includes a rear wheel assembly, which is detachably connected to the bottom frame.

In one embodiment, the rear wheel assembly includes two rear wheels, a linking assembly and a brake assembly, the rear wheels are connected to two ends of the linking assembly, the brake assembly is disposed on the linking assembly and is connected to the rear wheels through the linking assembly, and when the brake assembly is pressed, the linking assembly is moved to fix the rear wheels.

In one embodiment, the rear wheel assembly further includes a motor module, and the motor module is disposed on the linking assembly for driving the rear wheels to rotate.

In one embodiment, the moving carrier further includes a side door disposed at one side of the body frame assembly, and the side door is connected to the body frame assembly through a hinge mechanism.

In one embodiment, the moving carrier further includes a handle frame, the body frame assembly further includes a top frame, the top frame is connected to the bottom frame through the body stand frame, and two ends of the handle frame are connected to the top frame.

In one embodiment, the moving carrier further includes a second unlocking mechanism disposed on the handle frame and configured to unlock a lock state between the handle frame and the top frame. The second unlocking mechanism includes a second unlock member, a second connection member, and an engaging structure. The second unlock member is connected to the engaging structure through the second connection member. When the second unlock member is pressed, the second unlock member carries, through the second connection member, the engaging structure to depart from the top frame, so as to unlock the lock state between the handle frame and the top frame, so that the handle frame is relatively moveable with respect to the top frame.

In one embodiment, the second unlocking mechanism further includes a second stop member and a second elastic member, the second stop member is disposed on the handle frame for fixing one end of the second elastic member, and another end of the second elastic member is connected to the engaging structure.

To achieve the above, this disclosure also provides a seat folding method of a moving carrier. The moving carrier includes a body frame assembly, a seatback frame, a seat stand frame, a seat frame, and a first unlocking mechanism. The body frame assembly includes a body stand frame and a bottom frame connected to the body stand frame. The seatback frame is disposed on the body frame assembly and pivotally connected to the body stand frame. The seat stand frame is pivotally connected to the body frame assembly. The seat frame has a first end and a second end opposite each other, the first end is pivotally connected to the seatback frame and adjacent to a pivotal connection of the seatback frame and the body stand frame, and the second end is pivotally connected to the seat stand frame. The first unlocking mechanism is disposed on the seatback frame and configured to unlock a lock state between the seatback frame and the body frame assembly. The seat folding method includes the following steps of: operating the first unlocking mechanism to unlock the lock state between the seatback frame and the body frame assembly; and moving the seatback frame from an unfolded position to a folded position. While the seatback frame is moving from the unfolded position to the folded position, the seat stand frame is moving toward the bottom frame.

As mentioned above, in the moving carrier of this disclosure, the body frame assembly includes a body stand frame and a bottom frame connected to the body stand frame, the seatback frame is disposed on the body frame assembly and pivotally connected to the body stand frame, the seat stand frame is pivotally connected to the body frame assembly, the seat frame has a first end and a second end opposite each other, the first end is pivotally connected to the seatback frame and adjacent to a pivotal connection of the seatback frame and the body stand frame, the second end is pivotally connected to the seat stand frame, and the first unlocking mechanism is disposed on the seatback frame and configured to unlock a lock state between the seatback frame and the body frame assembly. When the first unlocking mechanism unlocks the lock state between the seatback frame and the body frame assembly, the seatback frame moves from an unfolded position to a folded position, and while the seatback frame is moving from the unfolded position to the folded position, the seat stand frame is moving toward the bottom frame. According to this design, the moving carrier of this disclosure can be used as an infant stroller or a baby carriage when the seat is unfolded, and can be used as a storage trolley or cart when the seat is folded.

### BRIEF DESCRIPTION OF THE DRAWINGS

The disclosure will become more fully understood from the detailed description and accompanying drawings, which are given for illustration only, and thus are not limitative of the present disclosure, and wherein:

FIGS. 1 and 2 are schematic diagrams in different viewing angles of a moving carrier according to an embodiment of this disclosure;

FIGS. 3A to 3C are schematic diagrams showing the folding process of the seat of the moving carrier of FIG. 1;

FIGS. 4A and 4B are schematic diagrams showing the first unlocking mechanism of the moving carrier of FIG. 1 before and after it is unlocked;

FIGS. 5A and 5B are schematic diagrams showing different kinds of the rear wheel assembly in the moving carrier according to an embodiment of this disclosure;

FIG. 6 is a schematic diagram showing the moving carrier according to an embodiment of this disclosure, wherein the handle frame can be rotated to different positions with respect to the body frame assembly; and

FIGS. 7A and 7B are schematic diagrams showing the second unlocking mechanism of the moving carrier of FIG. 6 before and after it is unlocked.

### DETAILED DESCRIPTION OF THE DISCLOSURE

The present disclosure will be apparent from the following detailed description, which proceeds with reference to the accompanying drawings, wherein the same references relate to the same elements.

The components shown in the drawings of the following embodiments are only used to illustrate their relative relationships and do not represent the actual proportions or sizes of the components.

The moving carrier of this disclosure is a cart equipped with wheels and a seat, and can be a handcart or an electric cart, such as, for example but not limited to, an infant stroller, a baby stroller, a pet stroller, a shopping cart, or other types of carts. The moving carriers of the following embodiments are, for example, infant strollers or baby strollers.

The term "connection" as used in this disclosure encompasses both "relatively movable connections" and "immovable connections." The "relatively movable connection" can be a pivotal connection, where the first object is fixed but the second object can move or rotate relative to the first one. The "immovable connection" can be a fixed connection, where the two objects cannot move or rotate relative to each other.

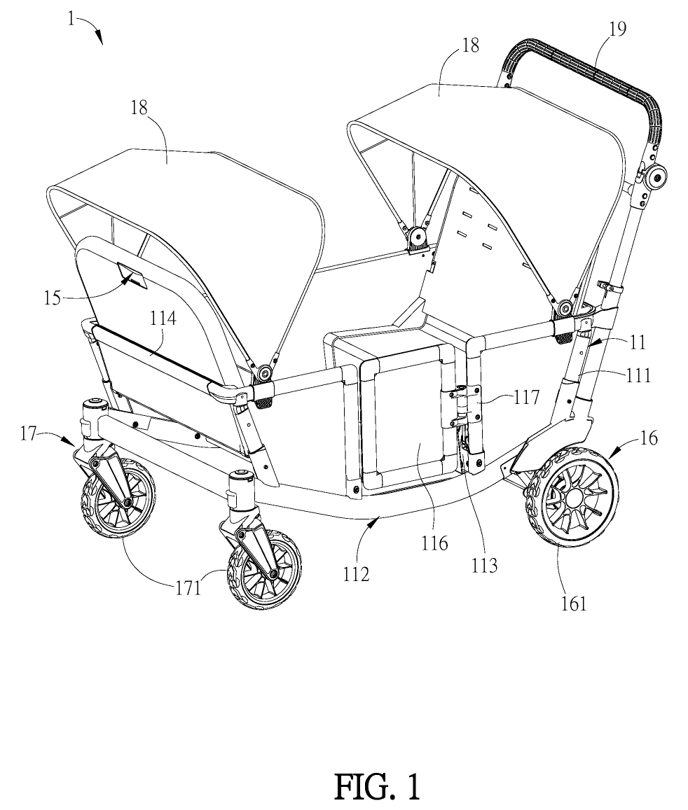

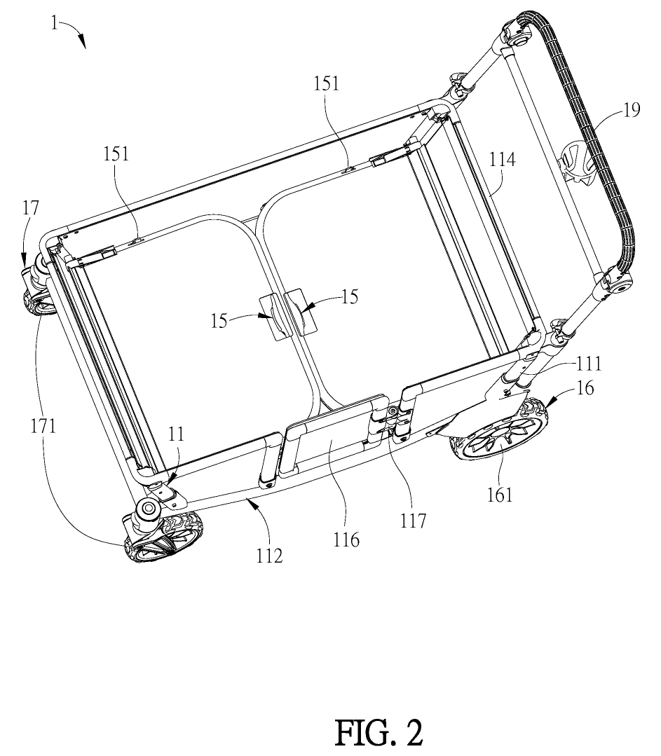

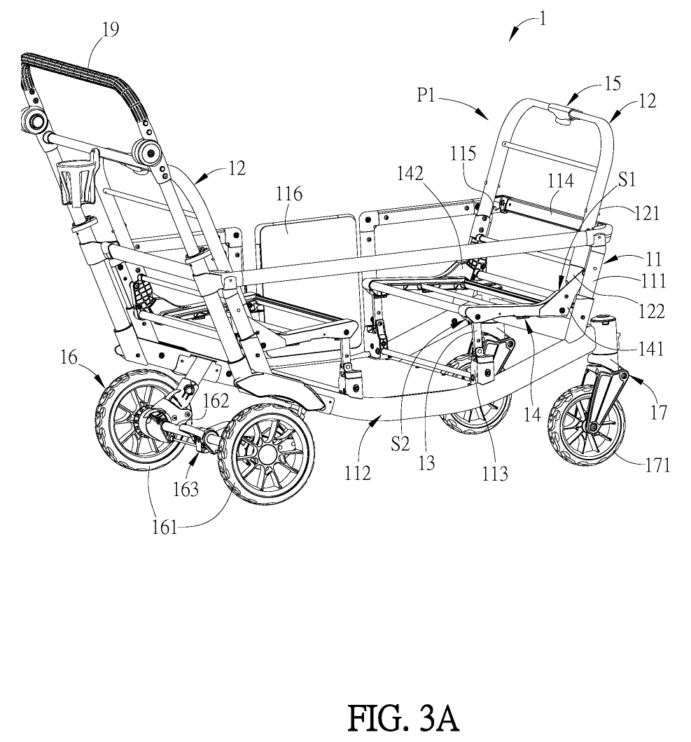

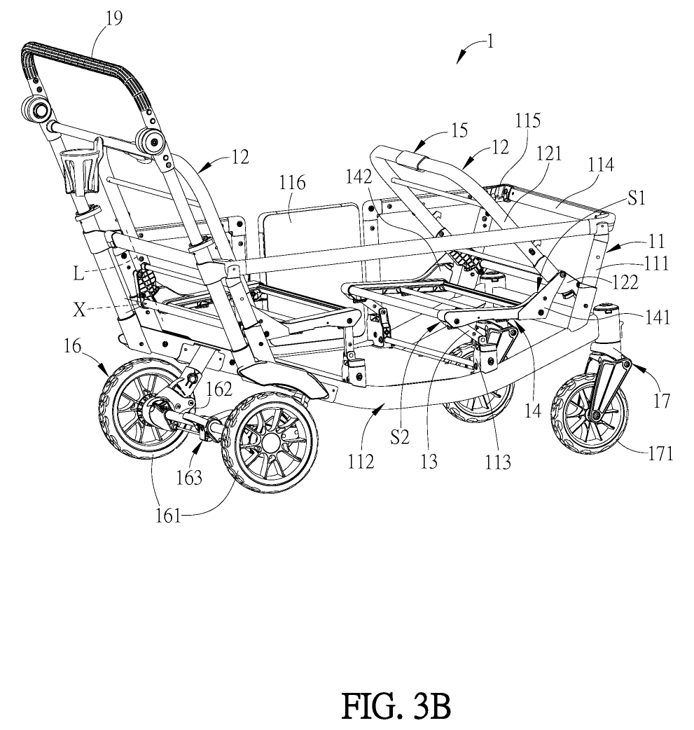

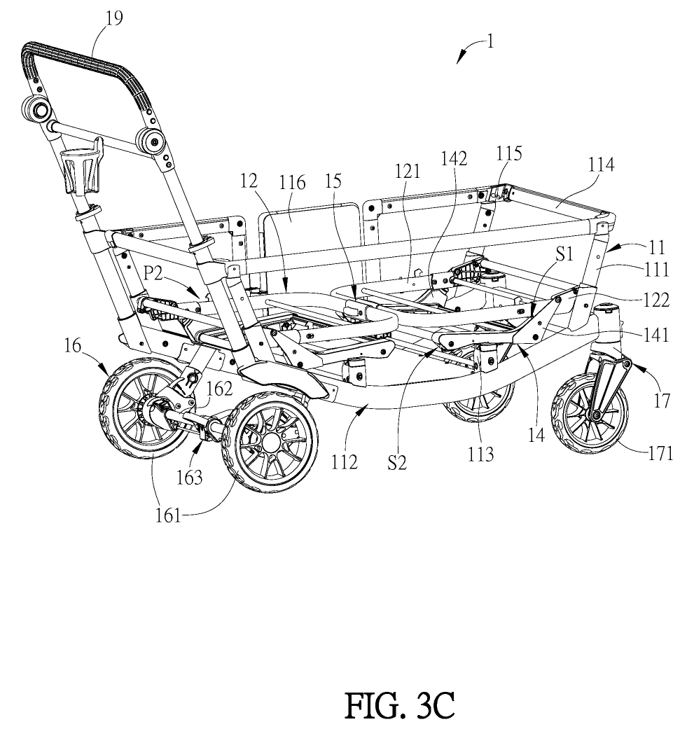

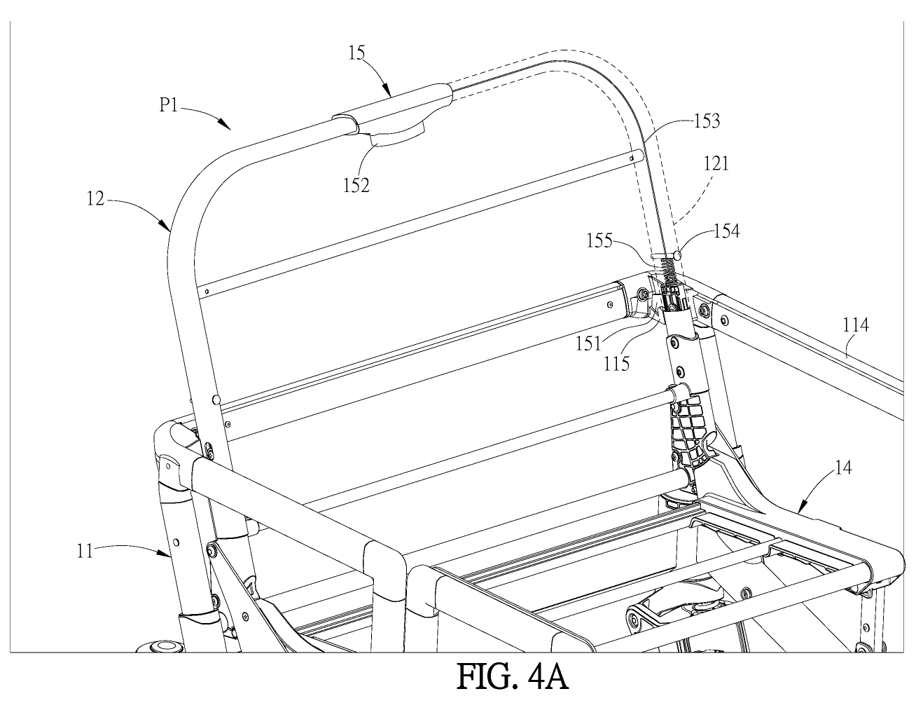

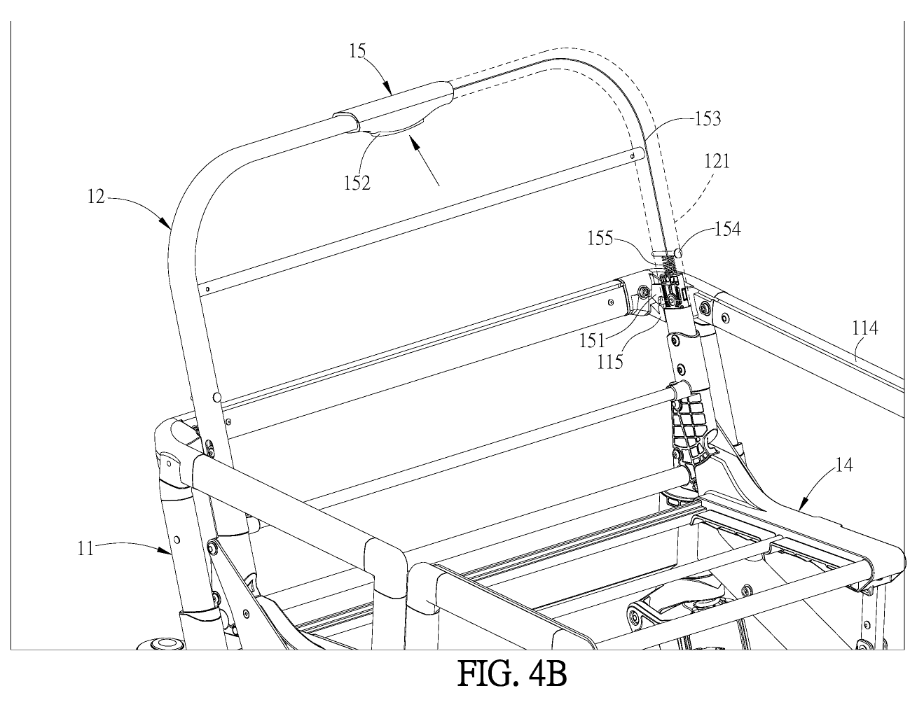

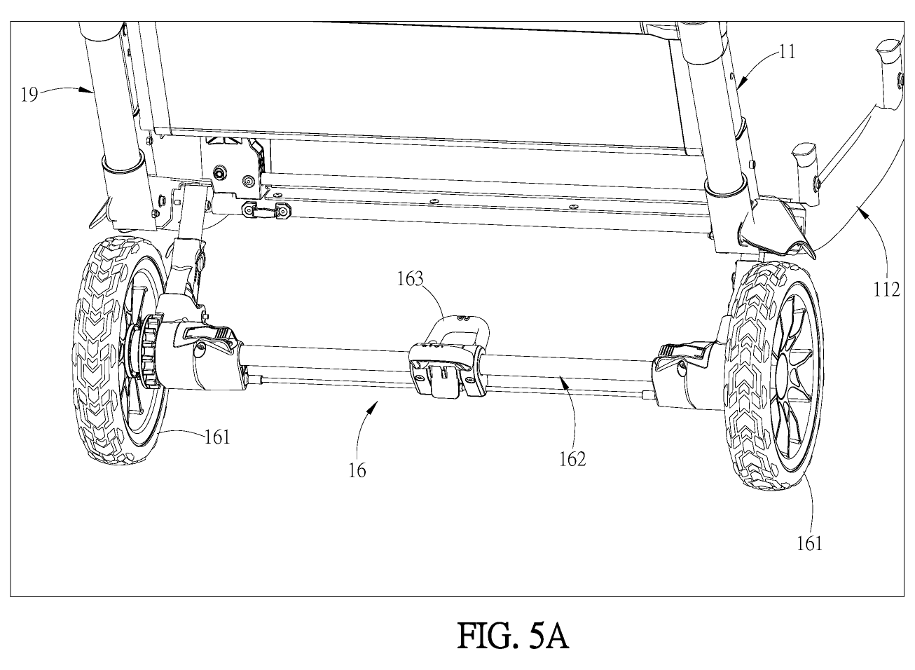

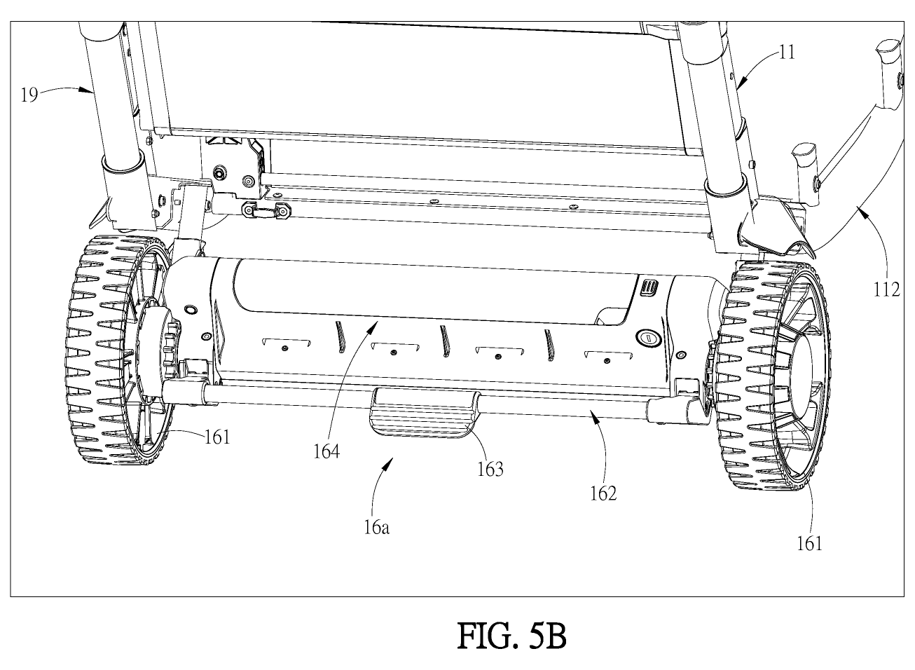

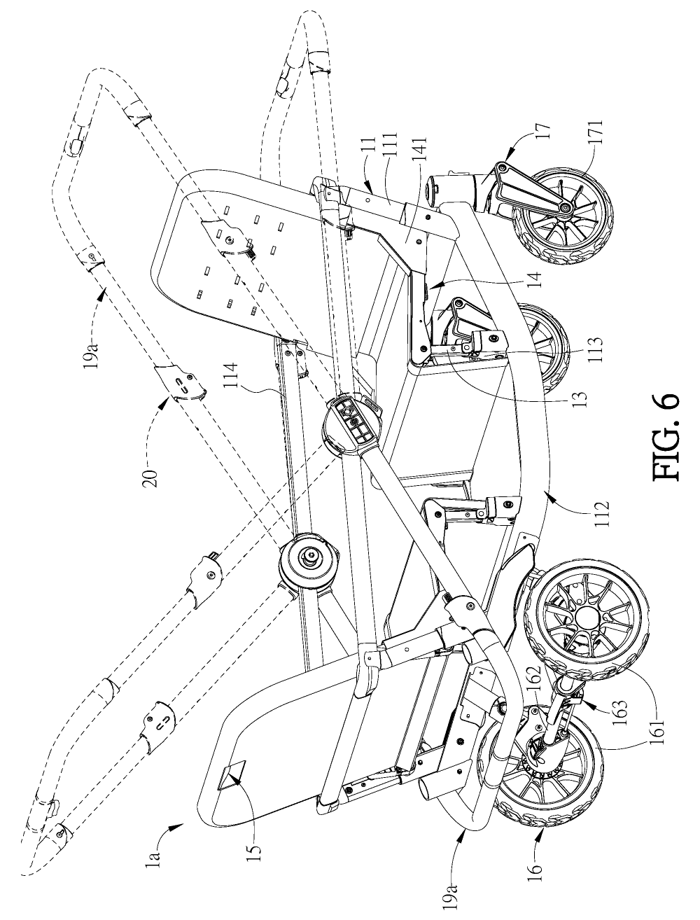

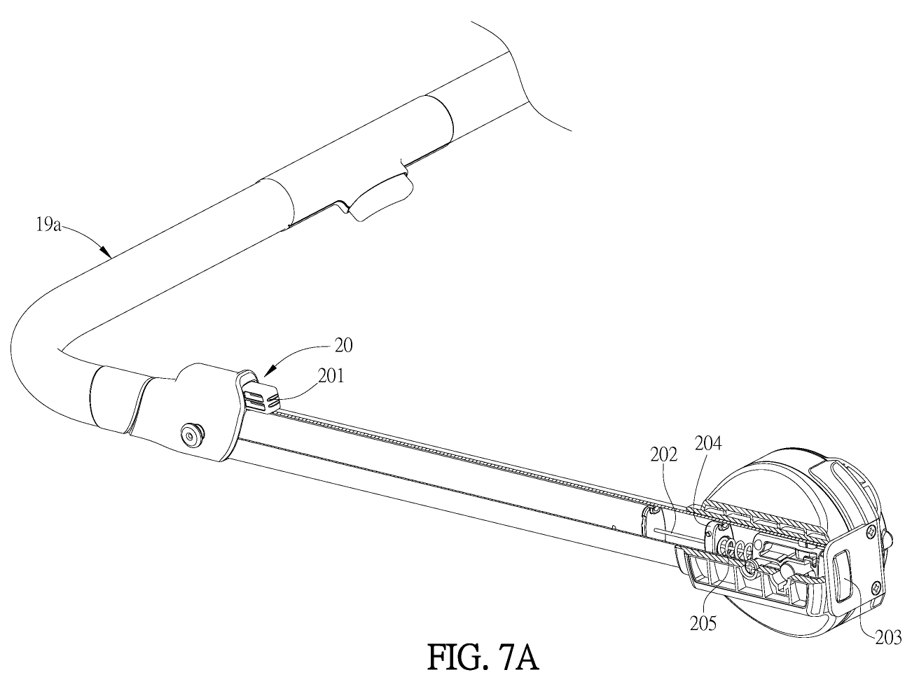

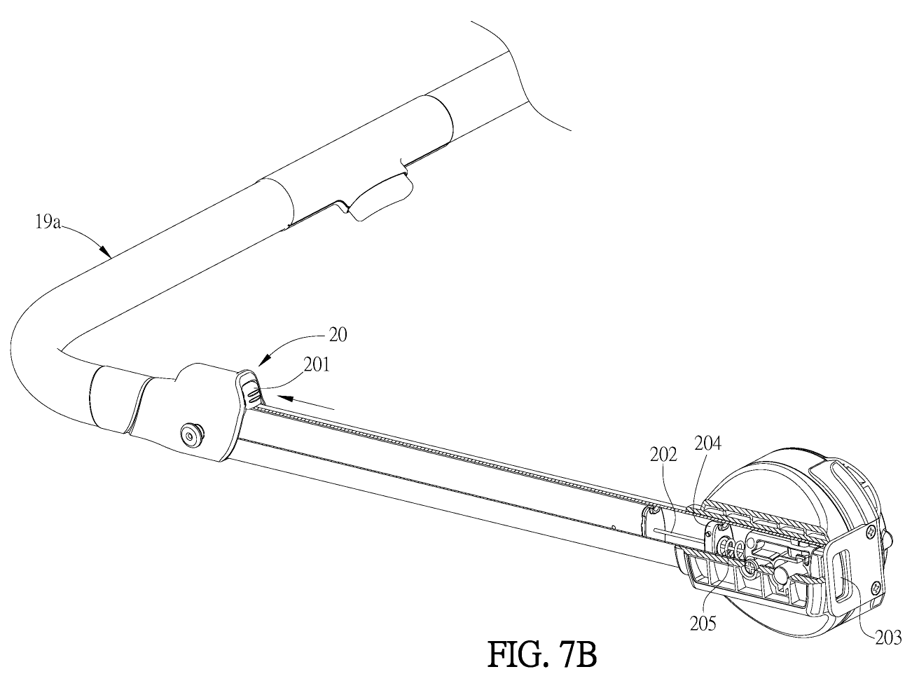

FIGS. 1 and 2 are schematic diagrams in different viewing angles of a moving carrier according to an embodiment of this disclosure. FIGS. 3A to 3C are schematic diagrams showing the folding process of the seat of the moving carrier of FIG. 1. FIGS. 4A and 4B are schematic diagrams showing the first unlocking mechanism of the moving carrier of FIG. 1 before and after it is unlocked. FIGS. 5A and 5B are schematic diagrams showing different kinds of the rear wheel assembly in the moving carrier according to an embodiment of this disclosure. FIG. 6 is a schematic diagram showing the moving carrier according to an embodiment of this disclosure, wherein the handle frame can be rotated to different positions with respect to the body frame assembly. FIGS. 7A and 7B are schematic diagrams showing the second unlocking mechanism of the moving carrier of FIG. 6 before and after it is unlocked.

To clearly illustrate the structure of the moving carrier, FIG. 1 shows that the hood, seatback, seat and body of the moving carrier are covered by fabrics, FIG. 2 shows that only the seatback, seat and body of the moving carrier are covered by fabrics, FIGS. 3A to 4B show only the frame (skeleton) of the moving carrier without the fabrics, and FIG. 6 shows that only the seatback and seat are covered by fabrics. Furthermore, the seat (seatback frame 12) in FIG. 3A is in an unfolded position P1, suitable for carrying infants or children, while the seat (seatback frame 12) in FIG. 3C is in a folded position P2, suitable for storing items (e.g. a storage trolley or cart).

Referring to FIGS. 1 to 4B, the moving carrier 1 of this embodiment includes a body frame assembly 11, a seatback frame 12, a seat stand frame 13, a seat frame 14, and a first unlocking mechanism 15. In addition, the moving carrier 1 may further include a rear wheel assembly 16, a front wheel assembly 17, two hoods 18, and a handle frame 19.

In a top view of the moving carrier 1, a projection of the body frame assembly 11 is substantially a quadrilateral. The body frame assembly 11 includes a body stand frame 111 and a bottom frame 112 connected to the body stand frame 111. In this embodiment, the body frame assembly 11 includes four body stand frames 111, which are connected (fixed) to the four corners of the bottom frame 112, respectively. In addition, the body frame assembly 11 may further include four stand base frames 113 and a top frame 114. The stand base frames 113 are fixed at four positions on the bottom frame 112, and the top frame 114 are fixed to the bottom frame 112 through four body stand frames 111.

The seatback frame 12 is disposed on the body frame assembly 11 and pivotally connected to the body stand frame 11. Accordingly, the seatback frame 12 is movable relative to the body stand frame 111 (the body frame assembly 11). In this embodiment, the moving carrier 1 includes two seatback frames 12, which are arranged opposite to each other (face-to-face). Each seatback frame 12 include at least one seatback stand frame 121 pivotally connected to the body stand frame 111. In this embodiment, each seatback frame 12 includes two seatback stand frames 121, so that the moving carrier 1 totally includes four seatback stand frames 121. These seatback stand frames 121 are arranged corresponding to and pivotally connected to the body stand frames 111 respectively.

Referring to FIGS. 3B and 3C, in this embodiment, the seatback stand frame 121 is pivotally connected to the body stand frame 111 through a first connection structure 122. As indicated by the dashed line L in FIG. 3B, the extension direction of the seatback stand frame 121 does not pass through the pivotal connection X of the first connection structure 122 and the body stand frame 111. This configuration allows the seatback frame 12 to be closer to the base frame 112 when moving from the unfolded position P1 to the folded position P2, thereby increasing the storage space between the seatback frames 12 and, consequently, the storage space of the moving carrier 1.

The seat stand frame 13 is pivotally connected to the body frame assembly 11. In this embodiment, the moving carrier 1 includes four seat stand frames 13, which are pivotally connected to the four stand base frames 113, respectively, so that each seat stand frame 13 can rotate with respect to the corresponding stand base frame 113. To be understood, in other embodiments, the moving carrier may be not configured with the stand base frame 113, and the seat stand frames 13 can be pivotally connected to the bottom frame 112 directly and can move relative to the bottom frame 112. This disclosure is not limited thereto.

The seat frame 14 has a first end S1 and a second end S2 opposite each other. The first end S1 is pivotally connected to the seatback frame 12 and adjacent to the pivotal connection of the seatback frame 12 and the body stand frame 111, and the second end S2 is pivotally connected to the seat stand frame 13. In this embodiment, the first end S1 of the seat frame 14 is pivotally connected to the seatback stand frame 121 through a second connection structure 141. In addition, the seat frame 14 has a supporting portion 142 disposed at the first end S1. In the folded position P2 (see FIG. 3C), the seatback stand frame 121 rests on the supporting portion 142, allowing for smooth folding without mechanical interference between the seatback stand frame 121 and the seat frame 14.

The first unlocking mechanism 15 is disposed on the seatback frame 12 and configured to unlock a lock state between the seatback frame 12 and the body frame assembly 11. When the first unlocking mechanism 15 unlocks the lock state between the seatback frame 12 and the body frame assembly 11, the seatback frame 12 moves from an unfolded position P1 (see FIG. 3A) to a folded position P2 (see FIG. 3C). In this embodiment, the moving carrier 1 includes two first unlocking mechanisms 15, which are disposed on two seatback frames 12, respectively, for unlocking the corresponding seatback frame 12.

Referring to FIGS. 4A and 4B, in this embodiment, the first unlocking mechanism 15 includes a first hook structure 151, and the body frame assembly 11 further includes a second hook structure 115 arranged corresponding to the first hook structure 151. When the seatback frame 12 is locked to the body frame assembly 11, the first hook structure 151 is engaged with the second hook structure 115. Therefore, in the unfolded position P1, the relative positions of the seatback frame 12 and the body frame assembly 11 can be fixed. In some embodiments, the first unlocking mechanism 15 may include one or two first hook structures 151 to respectively engage with one or two second hook structures 115 corresponding to the top frame 114. To be understood, if there are two first hook structures 151 and two second hook structures 115, the two first hook structures 151 may be located on the seatback stand frames 121 disposed at two sides of the seatback frame 12, and may be unlocked simultaneously by the first unlocking mechanism 15.

The first unlocking mechanism 15 further includes a first unlock member 152 and a first connection member 153, and the first unlock member 152 is connected to the first hook structure 151 through the first connection member 153. When the first unlock member 152 is pressed, the first unlock member 152 can carry, through the first connection member 153, the first hook structure 151 to depart from the second hook structure 115, so as to unlock the lock state between the seatback frame 12 and the body frame assembly 11. In addition, the first unlocking mechanism 15 may further include a first stop member 154 and a first elastic member 155, and the first connection member 153 passes through the first elastic member 155 and connects the first hook structure 151. The first stop member 154 is disposed on the seatback stand frame 121 for fixing one end of the first elastic member 155, and another end of the first elastic member 154 is connected to the first hook structure 151. In this case, the first connection member 153 can be, for example but not limited to, a steel cable, the first stop member 154 can be, for example but not limited to, a screw or an insert, and the first elastic member 155 can be, for example but not limited to, a spring. The first hook structure 151, the first connection member 153 and the first elastic member 155 are disposed inside the seatback frame 12 (seatback stand frame 121).

Therefore, when the user presses the first unlock member 152 (FIG. 4B), the first unlock member 152 carries, through the first connection member 153, the first hook structure 151 to disengage from the second hook structure 115 provided on the top frame 114, thereby allowing the seatback frame 12 to move from the unfolded position P1 to the folded position P2. During the movement of the seatback frame 12 from the unfolded position P1 to the folded position P2, the seatback frame 12 and the seat frame 14 move toward the bottom frame 112, while the seat stand frame 13 also moves toward the bottom frame 112. Furthermore, referring to FIG. 3C, in the folded position P2, the two seatback frames 12 substantially form a plane, and the extension direction of the seatback frame 12 (the seatback stand frame 121) is substantially parallel to the extension direction of the seat frame 14.

Referring to FIG. 1, the side door 116 is disposed on a side of the body frame assembly 11 and is connected to the body frame assembly 11 through a hinge mechanism 117 (see FIG. 1). Accordingly, passengers, such as children, can get on or off the moving carrier 1 through the side door 116.

Both the front wheel assembly 17 and the rear wheel assembly 16 are mounted on the bottom frame 112. The bottom frame 112 has a front side and a rear side. The front wheel assembly 17 includes two front wheels 171 connected to two ends of the front side of the bottom frame 112. The rear wheel assembly 16 includes two rear wheels 161 connected to two ends of the rear side of the bottom frame 112. Furthermore, two hoods 18 are provided for shielding sunlight or rain and are mounted on two sides of the top frame 114, corresponding to the two seats.

The handle frame 19 is connected to the body frame assembly 11. In this embodiment, the handle frame 19 is disposed at the rear side of the bottom frame 112 and is fixedly connected to the top frame 114 and the bottom frame 112.

In one embodiment, as shown in FIG. 5A, the rear wheel assembly 16 is detachably connected to the bottom frame 112. In addition to the two rear wheels 161, the rear wheel assembly 16 further includes a linking assembly 162 and a brake assembly 163. The two rear wheels 161 are connected to two ends of the linking assembly 162, while the brake assembly 163 is disposed on the linking assembly 162 and connected to the two rear wheels 161 through the linking assembly 162. When the user presses (steps) on the brake assembly 163, the two rear wheels 161 are fixed through the linking assembly 162. In other words, when the user presses (steps) on the brake assembly 163 and activates it, the rear wheels 161 can be locked, thereby preventing the moving carrier 1 from moving.

In another embodiment, as shown in FIG. 5B, the rear wheel assembly 16 can be modularly and quickly replaced with an electric rear wheel assembly 16a. In addition to the two rear wheels 161, the linking assembly 162, and the brake assembly 163, the rear wheel assembly 16a further includes a motor module 164. The motor module 164 is mounted on the linking assembly 162 to drive the two rear wheels 161 to rotate. In some embodiments, the motor module 164 may include a motor, a battery, and a transmission mechanism. When the user controls to activate the motor, the transmission mechanism can drive the two rear wheels 161 to rotate, turning the moving carrier 1 into an electric cart.

The moving carrier 1a of FIG. 6 is mostly the same as the moving carrier 1 of the previous embodiment. Unlike the moving carrier 1, the two ends of the handle frame 19a of the moving carrier 1a are connected to the body frame assembly 11 and can be locked to the body frame assembly 11 (top frame 114). After unlocking the handle frame 19a, the user can rotate the handle frame 19a relative to the top frame 114 to a desired position according to different usage scenarios, thereby holding the handle frame 19a to push or drag the moving carrier 1a, or folding the handle frame 19a under the top frame 114 to reduce the space occupied.

Referring to FIG. 6 in view of FIGS. 7A and 7B, the moving carrier 1a of this embodiment may further include a second unlocking mechanism 20. The second unlocking mechanism 20 is disposed on the handle frame 19a and is configured to unlock the lock state between the handle frame 19a and the top frame 114, allowing the handle frame 19a and the top frame 114 to rotate relative to each other.

The second unlocking mechanism 20 includes a second unlock member 201, a second connection member 202, and an engaging structure 203. The second unlock member 201 is connected to the engaging structure 203 through the second connection member 202. The top frame 114 may include a recess structure corresponding to the engaging structure 203 and located at the connection between the handle frame 19a and the top frame 114. When the user presses the second unlock member 201, the second unlock member 201 can be carried the engaging structure 203 through the second connection member 202 to depart from the recess structure, thereby releasing the lock state between the handle frame 19a and the top frame 114 and allowing the handle frame 19a to move relative to the top frame 114.

In addition, the second unlocking mechanism 20 may further include a second stop member 204 and a second elastic member 205. The second stop member 204 is disposed on the handle frame 19a for fixing one end of the second elastic member 205, and another end of the second elastic member 205 is connected to the engaging structure 203. In this embodiment, the second connection member 202 is, for example but not limited to, a steel cable, the second stop member 204 is, for example but not limited to, a stop plate, and the second elastic member 205 is, for example but not limited to, a spring for providing elastic force to push the engaging structure 203 back to the original position. The second connection member 202, the engaging structure 203, the second stop member 204 and the second elastic member 205 are all arranged in the handle frame 19a.

When the user presses the second unlocking mechanism 20 to unlock the lock state between the handle frame 19a and the top frame 114, the second unlock member 201 can carry, through the second connecting member 202, the engaging structure 203 to move inwardly so as to depart from the corresponding recess structure, thereby unlocking the lock state between the handle frame 19a and the top frame 114. Then, the handle frame 19a can be rotated to the desired position relative to the top frame 114.

To be noted, in some embodiments, the moving carrier 1a may include two second unlocking mechanisms 20 disposed on two sides of the handle frame 19a to respectively lock the top frame 114. In this case, the user must press two second unlock members 201 to unlock the lock state between the handle frame 19a and the top frame 114. However, if the user desires to unlock the lock state by operating only one of the second unlocking mechanisms 20, the user may disable the other second unlocking mechanism 20 in advance. For example, the engaging structure 203 of the other second unlocking mechanism 20 can be fixed at an unlocked (disabled) position, or be removed. Thus, even when the second unlock member 201 of the other second unlocking mechanism 20 is pressed, the corresponding engaging structure 203 cannot protrude to engage the corresponding recess structure of the top frame 114.

In summary, in the moving carrier of this disclosure, the body frame assembly includes a body stand frame and a bottom frame connected to the body stand frame, the seatback frame is disposed on the body frame assembly and pivotally connected to the body stand frame, the seat stand frame is pivotally connected to the body frame assembly, the seat frame has a first end and a second end opposite each other, the first end is pivotally connected to the seatback frame and adjacent to a pivotal connection of the seatback frame and the body stand frame, the second end is pivotally connected to the seat stand frame, and the first unlocking mechanism is disposed on the seatback frame and configured to unlock a lock state between the seatback frame and the body frame assembly. When the first unlocking mechanism unlocks the lock state between the seatback frame and the body frame assembly, the seatback frame moves from an unfolded position to a folded position, and while the seatback frame is moving from the unfolded position to the folded position, the seat stand frame is moving toward the bottom frame. According to this design, the moving carrier of this disclosure can be used as an infant stroller or a baby carriage when the seat is unfolded, and can be used as a storage trolley or cart when the seat is folded.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A moving carrier, comprising:
a body frame assembly comprising a body stand frame and a bottom frame connected to the body stand frame;
a seatback frame disposed on the body frame assembly and pivotally connected to the body stand frame;
a seat stand frame pivotally connected to the body frame assembly;
a seat frame having a first end and a second end opposite each other, wherein the first end is pivotally connected to the seatback frame and adjacent to a pivotal connection of the seatback frame and the body stand frame, and the second end is pivotally connected to the seat stand frame; and
a first unlocking mechanism disposed on the seatback frame and configured to unlock a lock state between the seatback frame and the body frame assembly;
wherein, when the first unlocking mechanism unlocks the lock state between the seatback frame and the body frame assembly, the seatback frame moves from an unfolded position to a folded position, and while the seatback frame is moving from the unfolded position to the folded position, the seat stand frame is moving toward the bottom frame.

2. The moving carrier of claim 1, wherein in a top view of the moving carrier, a projection of the body frame assembly is substantially a quadrilateral.

3. The moving carrier of claim 1, wherein the body frame assembly further comprises a top frame, and the top frame is connected to the bottom frame through the body stand frame.

4. The moving carrier of claim 1, wherein the body frame assembly comprises a plurality of the body stand frames, and each of the body stand frames connects to one of multiple corners of the bottom frame.

5. The moving carrier of claim 1, wherein the moving carrier comprises a plurality of the seatback frames, and the seatback frames are disposed opposite to each other.

6. The moving carrier of claim 5, wherein in the folded position, the seatback frames substantially form one plane.

7. The moving carrier of claim 1, wherein while the seatback frame is moving from the unfolded position to the folded position, the seatback frame and the seat frame are both moving toward the bottom frame.

8. The moving carrier of claim 1, wherein the seatback frame comprises a seatback stand frame, the seatback stand frame is pivotally connected to the body stand frame through a first connection structure, and an extension direction of the seatback stand frame does not pass through a pivotal connection of the first connection structure and the body stand frame.

9. The moving carrier of claim 1, wherein the seatback frame comprises a seatback stand frame, the first end of the seat frame is pivotally connected to the seatback stand frame through a second connection structure, the seat frame comprises a supporting portion arranged at the first end, and when the seatback is in the folded position, the seatback stand frame is disposed on the supporting portion.

10. The moving carrier of claim 1, wherein the first unlocking mechanism comprises a first hook structure, the body frame assembly further comprises a second hook structure arranged corresponding to the first hook structure, and when the seatback frame is locked to the body frame assembly, the first hook structure is engaged with the second hook structure.

11. The moving carrier of claim 10, wherein the first unlocking mechanism further comprises a first unlock member and a first connection member, the first unlock member is connected to the first hook structure through the first connection member, and when the first unlock member is pressed, the first unlock member carries, through the first connection member, the first hook structure to depart from the second hook structure, so as to unlock the lock state between the seatback frame and the body frame assembly.

12. The moving carrier of claim 11, wherein the first unlocking mechanism further comprises a first stop member and a first elastic member, the first connection member passes through the first elastic member and connects the first hook structure, the first stop member is disposed on the seatback stand frame for fixing one end of the first elastic member, and another end of the first elastic member is connected to the first hook structure.

13. The moving carrier of claim 1, further comprising:
a rear wheel assembly detachably connected to the bottom frame.

14. The moving carrier of claim 13, wherein the rear wheel assembly comprises two rear wheels, a linking assembly and a brake assembly, the rear wheels are connected to two ends of the linking assembly, the brake assembly is disposed on the linking assembly and is connected to the rear wheels through the linking assembly, and when the brake assembly is pressed, the linking assembly is moved to fix the rear wheels.

15. The moving carrier of claim 14, wherein the rear wheel assembly further comprises a motor module, and the motor module is disposed on the linking assembly for driving the rear wheels to rotate.

16. The moving carrier of claim 1, further comprising:
a side door disposed at one side of the body frame assembly, wherein the side door is connected to the body frame assembly through a hinge mechanism.

17. The moving carrier of claim 1, further comprising:
a handle frame, wherein the body frame assembly further comprises a top frame, the top frame is connected to the bottom frame through the body stand frame, and two ends of the handle frame are connected to the top frame.

18. The moving carrier of claim 17, further comprising:
a second unlocking mechanism disposed on the handle frame and configured to unlock a lock state between the handle frame and the top frame;
wherein, the second unlocking mechanism comprises a second unlock member, a second connection member, and an engaging structure, the second unlock member is connected to the engaging structure through the second connection member, and when the second unlock member is pressed, the second unlock member carries, through the second connection member, the engaging structure to depart from the top frame, so as to unlock the lock state between the handle frame and the top frame, so that the handle frame is relatively moveable with respect to the top frame.

19. The moving carrier of claim 18, wherein the second unlocking mechanism further comprises a second stop member and a second elastic member, the second stop member is disposed on the handle frame for fixing one end of the second elastic member, and another end of the second elastic member is connected to the engaging structure.

20. A seat folding method of a moving carrier, wherein the moving carrier comprises a body frame assembly, a seatback frame, a seat stand frame, a seat frame, and a first unlocking mechanism, the body frame assembly comprises a body stand frame and a bottom frame connected to the body stand frame, the seatback frame is disposed on the body frame assembly and pivotally connected to the body stand frame, the seat stand frame is pivotally connected to the body frame assembly, the seat frame has a first end and a second end opposite each other, the first end is pivotally connected to the seatback frame and adjacent to a pivotal connection of the seatback frame and the body stand frame, the second end is pivotally connected to the seat stand frame, and the first unlocking mechanism is disposed on the seatback frame and configured to unlock a lock state between the seatback frame and the body frame assembly, the method comprising:
operating the first unlocking mechanism to unlock the lock state between the seatback frame and the body frame assembly; and
moving the seatback frame from an unfolded position to a folded position;
wherein, while the seatback frame is moving from the unfolded position to the folded position, the seat stand frame is moving toward the bottom frame.
